(19) United States
(12) Patent Application Publication
(10) Pub. No.: US 2009/0102578 A1
(43) Pub. Date: Apr. 23, 2009

(54) BROADBAND PLANAR MAGIC-T WITH LOW PHASE AND AMPLITUDE IMBALANCE

(75) Inventors: Kongpop U-Yen, Alexandria, VA (US); Edward J. Wollack, Clarksville, MD (US); Terence A. Doiron, Annapolis, MD (US)

Correspondence Address: NASA GODDARD SPACE FLIGHT CENTER, 8800 GREENBELT ROAD, MAIL CODE 140.1, GREENBELT, MD, 20771, US

(73) Assignee: United States of America as represented by the Administrator of the National Aeronautics and Spac, Washington, DC (US)

(21) Appl. No.: 12/141,246

(22) Filed: Jun. 18, 2008

Related U.S. Application Data
(63) Continuation-in-part of application No. 11/877,102, filed on Oct. 23, 2007.
(60) Provisional application No. 61/020,917, filed on Jan. 14, 2008.

(51) Int. Cl. H01P 5/20

(52) U.S. Cl. 333/122

(57) ABSTRACT

A planar Magic-T that incorporates complementary microstrip-slotline tee junction and microstrip-slotline transition area to produce a compact broadband out-of-phase combining structure with minimum loss due to slotline radiation. The Magic-T structure layout is symmetric which causes the structure to be less dependent on the transmission line phase variation. The Magic-T produces broadband in-phase and out-of-phase power combiner/divider responses, has low in-band insertion loss, and small in-band phase and amplitude imbalance. A multi-section impedance transformation network is used to increase the operating bandwidth and minimize the parasitic coupling around the microstrip-slotline tee junction. As a result, the improved magic-T has greater bandwidth and lower phase imbalance at the sum and difference ports than the earlier magic-T designs.

### CROSS REFERENCE TO RELATED APPLICATIONS

This application claims the benefit of U.S. Provisional Application Ser. No. 61/020,917, filed Jan. 14, 2008, title “Broadband Planar Magic-T With Low Phase and Amplitude Imbalance,” under 35 U.S.C. 119(e), and is a Continuation in Part (CIP) of prior application Ser. No.11/877,102, filed Oct. 23, 2007, titled “A Compact Magic-T Using MicroStrip Slotline Transitions,” the contents of each are herein incorporated by reference.

### ORIGIN OF THE INVENTION

The invention described herein was made by employees of the United States Government and may be manufactured and used by or for the government for government purposes without payment of any royalties thereon or therefore.

### FIELD OF THE INVENTION

This invention relates to microwave devices, especially Magic-Tee or Magic-T couplers, and more particularly, to a device suitable for use in radar and communications systems.

### BACKGROUND

Planar Magic-Ts are used in microwave integrated circuits to split or combine in-phase and out-of-phase signals. Applications include balanced-mixers, discriminators, interferometers, and beam-forming networks. Desirable properties of a magic-T include wide bandwidth phase and amplitude balance, low insertion loss, high isolation, compact size, and fabrication simplicity.

The factors that limit Magic-T isolation are unequal phase delay and impedance mismatch between the input ports. Unequal phase delay commonly results from lack of symmetry in the structure and asymmetric parasitic coupling between the input ports. Proposed prior art solutions have increased fabrication complexity with decreased electrical performance, increased high insertion loss and radiation, and a decreased in overall achievable isolation due to the lack of physical symmetry between the input ports.

Several techniques have been developed to provide broadband response to a Magic-T. Co-planar waveguide (CPW) or microstrip (MS) to slotline (SL) mode conversion techniques are widely incorporated in a Magic-T to produce a broadband out-of-phase power combiner or divider such that the slotline transmission becomes the main part of these Magic-Ts. Since a slotline has less field confinement than a microstrip or a CPW, slotline radiation can cause high insertion loss in these Magic-Ts. In addition, the Magic-T constructed from CPW transmission lines requires the bonding process for air bridges which increases fabrication complexity. Although aperture coupled Magic-Ts have a small slot area, however, aperture coupled Magic-Ts require three metal layers causing high insertion loss and radiation.

For at least the reasons stated above, and for other reasons stated below which will become apparent to those skilled in the art upon reading and understanding the present specification, there is a need in the art for a Magic-T with low phase and amplitude imbalance There is also a need for improved Magic-T with reduced slotline radiation.

### SUMMARY

The above-mentioned shortcomings, disadvantages and problems are addressed herein, which will be understood by reading and studying the following specification.

The invention uses the complementary properties of microstrip and slotline to produce a compact broadband out-of-phase combining structure with minimum loss due to slot line radiation. The structure has low loss and is highly symmetric which causes the structure to be less dependent on the transmission line phase variation. As a result, the structure has high port E-H isolation, extremely high phase balance, and has broadband response. The overall bandwidth is mainly limited by the slotline termination and the impedance transformation at the port The ability to combine signal using only transmission line and slotline without incorporating complex fabrication processes such as bondwires, viaholes or airbridges.

In one aspect, a microwave circuit arrangement includes a Magic-T waveguide circuit element with a first and second input port and a sum port. The input ports are each positioned one quarter wavelength away from the sum port. The microwave circuit arrangement further includes a microstrip slotline transition circuit with a difference port, and a slotline coupling the Magic-T waveguide circuit element and the microstrip slotline transition circuit.

In another aspect, a method of manufacturing a multi-port Magic-T, positioning in the Magic-T includes waveguide circuit a first input port at a quarter wavelength away from a sum port, positioning in the Magic-T waveguide circuit a second input port at a quarter wavelength away from the sum port, coupling to the Magic-T waveguide circuit a slotline having a first and second end, and coupling a microstrip slotline transition circuit towards the second end of the slotline. The manufactured Magic-T causes a ground at the sum port when the received signals at a first input port and a second input port are out-of-phase. In addition, the manufactured Magic-T isolates the difference port when the received signals at the first input port and second input port are in-phase.

In still another aspect, a multi-port circuit for processing two incoming signals of arbitrary phase and amplitude to output two corresponding output signals. The multi-port circuit has two input ports connecting with transmission line and are combined in-phase at a sum port. The transmission line is at least a quarter wavelength long. The multi-port circuit further provides a first half-wavelength long transmission line connecting a junction node and the first input port, a second half-wavelength long transmission line connecting a junction node and the second input port, a slotline having a first and second end terminated with slotline stepped circular ring (SCR) so that the input signals are combined at the junction node when the first and second incoming signals are out-of-phase, and wherein the first and second incoming signals are combined at the sum port when the first and second incoming signals are in-phase.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 illustrates a Magic-T microwave circuit arrangement;

FIG. 2 illustrates a slotline with a first and second slotline stepped circular ring (SCR) used in the Magic-T shown in FIG. 1;

FIG. 3 illustrates a microstrip stepped impedance open-end stub used in the Magic-T shown in FIG. 1;

FIG. 4 illustrates the electric fields across a microstrip in the odd mode for the Magic-T shown in FIG. 1;

FIG. 5 illustrates the electric fields across a microstrip in an even mode for the Magic-T shown in FIG. 1;

FIG. 6 is a block diagram of an equivalent circuit in an odd mode for the Magic-T shown in FIG. 1;

FIG. 7 is a block diagram of an equivalent circuit in an even mode for the Magic-T shown in FIG. 1;

FIG. 8 illustrates the frequency response for the Magic-T shown in FIG. 1

FIG. 9 is a diagram of a Magic-T with a first and second input port coupled to the sum port through a one quarter wavelength long line in accordance to an embodiment; and

FIG. 10 is a diagram of a full circuit model of a Magic-T at the center of the operating frequency in accordance to an embodiment.

### DETAILED DESCRIPTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

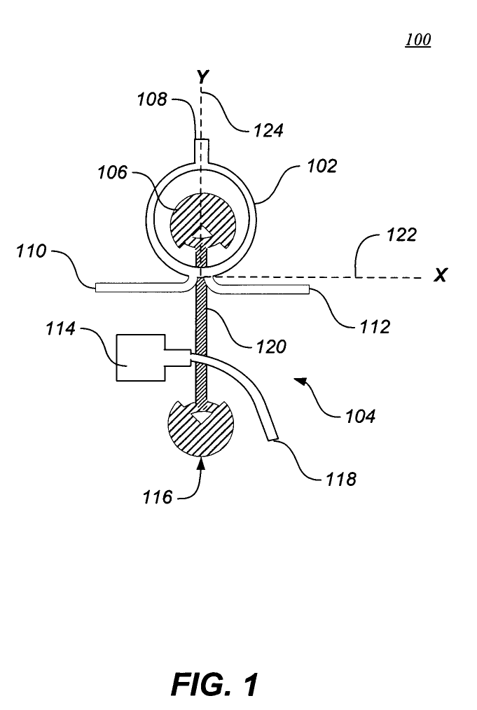

FIG. 1 is a representation of a Magic-T 100 according to an embodiment. The magic-T 100 comprises five λ/4 microstrip lines with characteristic impedances of Z₁, Z₂ and Zₜ. The illustrated magic-T 100 requires only one short section of the MS-to-SL transition to achieve a broadband 180 degree phase shift and an out-of-phase power combiner. Additionally, the magic-T 100 structure has a small total slotline area, thus, minimizing radiation loss and parasitic coupling to microstrip lines. The magic-T layout is also symmetric along the Y-axis 124 up to sum port 108. As a result, the parasitic coupling from slotline sections to microstrip line sections at port 110 and port 122 are substantially equal. Thus, the sum port 108 and difference port 118 isolation of the magic-T 100 exhibits broad-band characteristics. Moreover, the magic-T 100 does not require via holes, bondwires or airbridges which increase fabrication complexity and allow broadband operation in millimeter wave frequency. It also comprises a slotline (120) of length Ls with the slotline characteristic impedance of Z₀. All ports are terminated with the microstrip lines with the characteristic impedance of Z₀. The slotline 120 section is terminated with the slotline SCR termination (106, 116) at both ends to provide broadband and low-loss MS-to-SL transition and to allow out-of-phase combining to occur. Impedance Zₜ is used to transform slotline Zs to the microstrip line Z₀ at the difference port 118. The Magic-T (Magic-TEE) 100 comprises a Magic-T waveguide circuit element 102 having input ports 110 and 112 and a first slotline stepped circular ring (SCR) 106; and, microstrip-slotline (MS-SL) junction having an input/output port 118 that ends with a microstrip stepped impedance open end (SIO) stub, and a second SCR 116. Additionally, the first and second SCR are connected by slotline 120. The Magic-T (Magic-TEE) 100 includes quarter-wavelength (λ/4) microstrip lines with the characteristic impedances of Z₁, Z₂ and Zₜ. The Z₁ line with the length of L₁ is used to transform the characteristic impedance Z₀ at port 1 (110) or port 2 (112) to a slotline impedance (Zs) at the center of the structure (Axis Y, 124), Z₁ and Zₜ, lines (with the length of L₁ and L₂, respectively) are used for transforming impedance from slotline impedance to Z₀ at the sum port or port H (port108) and at the difference port or port E (port 118), respectively. The magic-T 100 also includes slotline 120 (Zs), with the length of L_{S}. One end of the Zₜ line (port 118) is terminated with a microstrip stepped impedance open-end (SIO) stub 114 to produce a broadband virtual ground for the MS-SL transition. The SIO stub 114 includes microstrip lines with the characteristic impedances of Z_{T1} and Z_{T2} and the associated parameters describing widths and lengths (θ_{T1} and θ_{T2}).

The ends of the slotline, having impedance Z_{S}, are coupled to slotline stepped circular ring (SCR) 106 and 116 to provide broadband and low-loss MS-SL transition and to allow out-of-phase combining at MS-SL tee junction 204 along the X-plane 122 of the Magic-T waveguide circuit element 102. The signals from the first port 110 and the second port 112 are combined out-of-phase at the MS-SL tee junction along X-plane and combined in-phase at output port 108.

A slotline termination (120, 106) is used at the MS-SL tee junction to provide a slotline virtual open and allow mode conversion in the out-of-phase combiner. It is also used in the MS-SL transition at input/output port 118 (port E). A slotline SCR termination is used in the Magic-T waveguide circuit element 102 due to its compact size and because the slotline SCR termination (106) minimizes the effect of parasitic and slotline radiation in slotline (116, 106). While Magic-T 100 has been described with planar waveguide circuits, it should be understood by those in the art that planar alternatives can be used such as retrace hybrid and planar magic-Ts using microstrip-coplanar waveguide transitions.

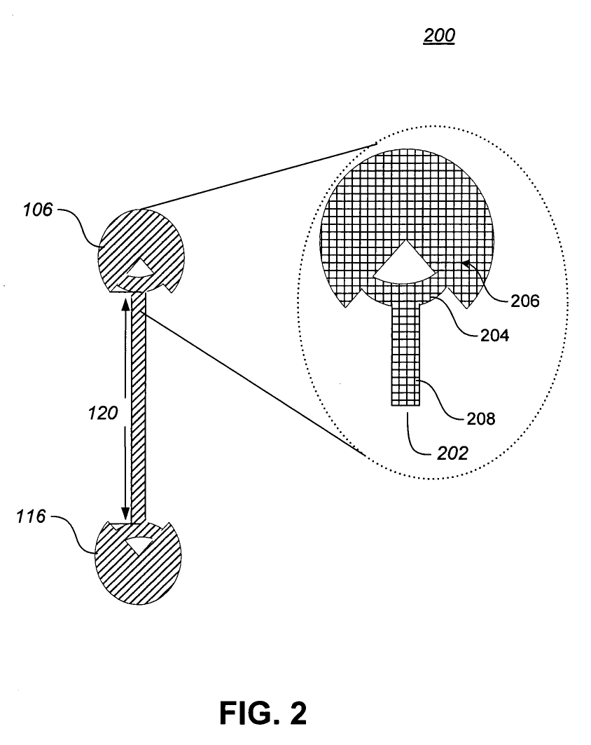

FIG. 2 is an illustration of slotline SCR 200 having a slotline 120 with a first SCR 106 and second SCR 116 coupled at each end. The slotline SCR 106 and 116 comprises three slotline sections 204, 206, 208 with the characteristic admittances, physical lengths, and electrical lengths. Due to symmetry, the circular structure forces the electric field (E-field) at input 202 to cancel at center of 206, creating low-loss virtual ground over the operating band. The slotline SCRs (106, 116) are used in Magic-T 100 as open terminations for the microstrip-to-slotline transition when the signals from the first input port 110 and second input port 112 are out-of-phase.

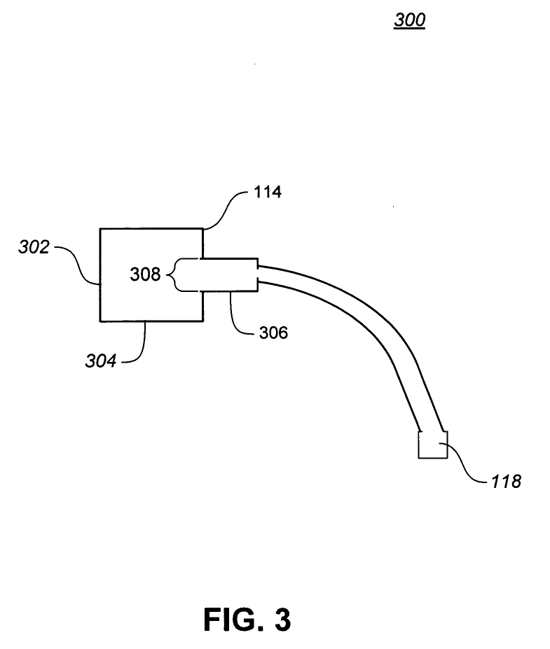

FIG. 3 is an illustration of a microstrip stepped impedance opened (SIO) stub 300 in accordance to an embodiment. The SIO stub 114 is comprised of microstrip lines with characteristic impedances and associated electrical lengths. The impedance of the SIO Zₜ₁ and Zₜ₂ have the physical widths and lengths of Wₜ₁ (308) and Wₜ₂ (302), and Lₜ₁ (306) and Lₜ₂ (304), respectively. These electrical lengths are tuned such that the SIO stub 114 provides a virtual ground at the fundamental frequency (f₀).

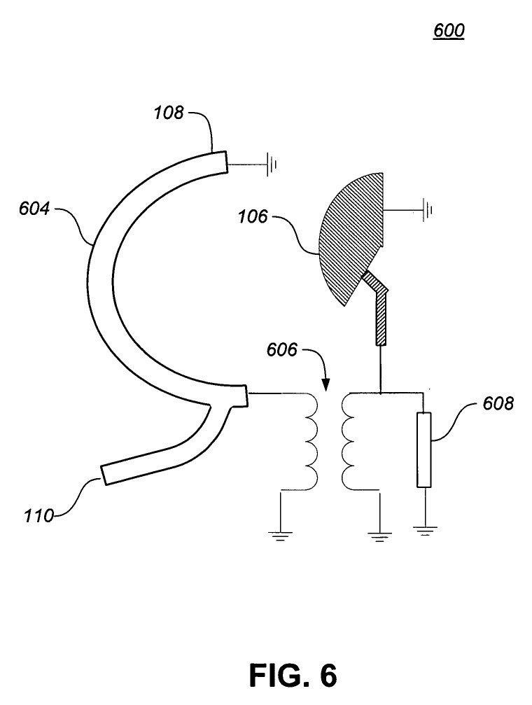

The slotline SCR termination 106 can be modeled as stepped impedance transmission lines, for example, as shown in FIG. 6. Its equivalent circuit parameters and its physical parameters designed on 0.25 mm—thick Duriod® 6010 substrate are provided in Table I and Table II, respectively.

TABLE I
The Magic-T Circuit Design Parameters at 10 GHZ

| MICROSTRIP | |
|---|---|
| LINE SECTION | SLOTLINE SECTION |
| Z₁ = 42.7 Ω, Z₂ = 60.33 Ω, | Zₛ = 72.8 Ω, Zₛₗ₀ = 72.8 Ω, Zₛₗ₁ = 163.4 Ω, |
| Zₜ₁ = 40 Ω, Zₜ₂ = 20 Ω, | Zₛₗ₂ = 72.8 Ω, θₛₗ₀ = 13.57°, θₛₗ₂ = 6.2°, |
| θₜ₁ = 23.3°, θₜ₂ = 46.6° | θₛₗ₁ = 34.95°, θₛ = 113.3° |

TABLE II
The Physical Parameters of the Compact Magic-T in Millimeters

| Microstrip line section | Slotline section |
|---|---|
| L₁ = 2.62, W₁ = .26, L₂ = 1.83, W₂ = 0.14, | Lₛ = 1.92, Wₛ = 0.10, |
| Lₜ = 2.8, Wₜ = 0.16, Lₜ₁ = 0.68, Wₜ₁ = 0.37, | Lₛₒ = 0.58, Wₛₒ = 0.10, |
| Wₜ₁ = 0.37, Lₜ₂ = 1.30, Wₜ₂ = 1.05 | Lₛ₁ = 0.23, Wₛ₁ = 0.10, |
| | Lₛ₂ = 0.91, Wₛ₂ = 0.71 |

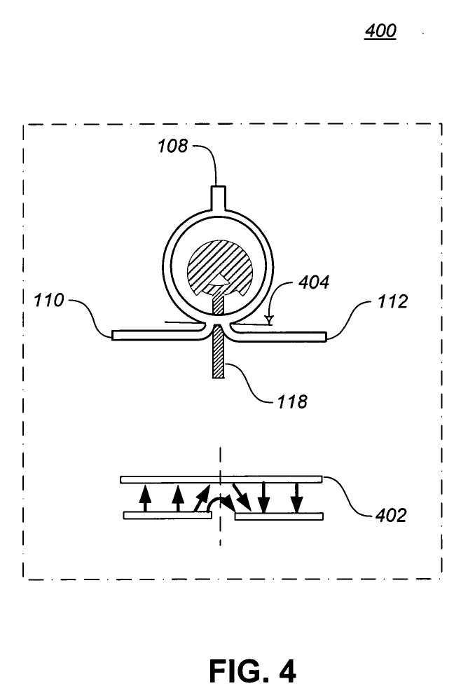

In the odd mode, the signals from the first port 110 and second port 112 are out-of-phase. This creates a microstrip virtual ground plane along the Y-axis 124 of the Magic-T 100. The slotline SCR (120,116) connected to the slotline 120 (Z_{SL}), also allows the MS-SL mode conversion to occurs as demonstrated by the electric-field (E-field) and current directions around the X-axis cross section as shown by 402 in FIG. 4.

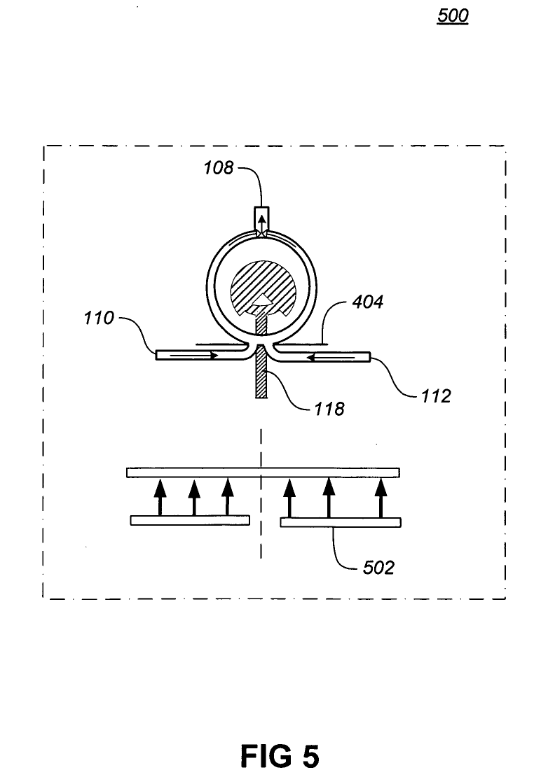

In the even mode, the signals from the first port 110 and second port 112 are in-phase, thus creating a microstrip virtual open along the Y-axis 124 of the Magic-T 100 as shown in FIG. 5. The electric fields (502 at FIG. 5) in the slotline at the MS-SL tee junction 404 along X-plane are canceled creating a slotline virtual ground that prevents the signal flow to or from port 118.

FIG. 6 is an illustration of the circuit model for Magic-T 100 in the odd mode. As noted earlier, the odd mode occurs when the signals from the first port 110 and the second port 112 are out-of-phase. The impedance of the first port 110 is labeled 602, the connecting impedance to port 108 is labeled as 604, and the half impedance of the line from the SIO to input/output port 118 is labeled as 608. In order to match the impedance of the four ports of the Magic-T (110, 112, 108, 118), the Magic-T 100 is analyzed at the center frequency in odd-mode and even-mode circuits up to the MS-SL tee junction 404. The odd mode circuit model the λ/4 line (Z₁ or the impedance at the first port 110) is used to transform the input characteristic impedance at the first port 110 to the desired impedance value of Z_{S}/2 (608) of the slotline 120. The slotline SCR 106 has no effect on the circuit at the center frequency since it is a virtual open at that frequency. Therefore, Z₁ can be derived as follows:

$${Z}_{1} = \sqrt{{N}_{l}^{2} \cdot \frac{{Z}_{s}}{2} \cdot {Z}_{0}} \qquad EQ . 1$$

where N₁, is the MS-SL transformer ratio. The λ/4 line Z₂ (the impedance at output port 108) is used to transform the grounded-end at port 108 to a virtual open at Z_{S}. The practical value of Z₂ is set by the impedance matching in the even-mode analysis.

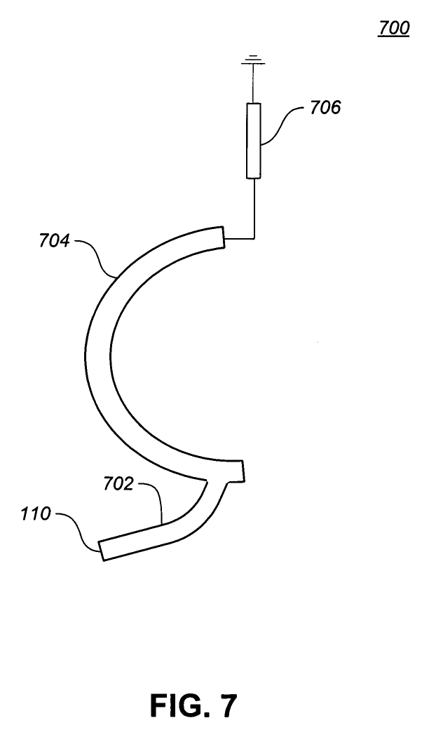

FIG. 7 is an illustration of the circuit model for Magic-T 100 in the even mode. As noted earlier, the even mode occurs when the signals from the first port 110 and the second port 112 are in-phase. The impedance of the first port 110 is labeled 702, the connecting impedance to port 108 is labeled as 704. Since a slotline virtual ground is created input/output port 118 is isolated from the rest of the other ports. In the even mode, the input impedance Z₀ at port 1 is transformed to the in-phase port impedance of 2Z₀ at 706. Since the line Z₁ is used to transform impedance Z₀ to Z_{S}/2 in odd-mode, the line Z₂ transforms the odd-mode impedance of Z_{S}/2 to 2Z₀ at 706. Therefore, Z₂ can be computed as follows:

$${Z}_{2} = \sqrt{2 {Z}_{0} \cdot {N}_{t}^{2} \cdot \frac{{Z}_{S}}{2}} = \sqrt{2} {Z}_{1} \qquad EQ . 2$$

The isolation between the first port 110 and the second port 112 and the return loss of the first port and the second port are derived in term of the reflective coefficients (Γ₊₋ and Γ₊₊) and defined as follows:

$$\begin{matrix}Isolation = - 20 log ( \frac{\vert {Γ}_{++} - {Γ}_{+ -} \vert}{2} ) & EQ . 3 \\ Return loss = - 20 log ( \frac{\vert {Γ}_{++} - {Γ}_{+ -} \vert}{2} ) . & EQ . 4\end{matrix}$$

In an exemplary design, for example, a Magic-T 100 is designed on a 0.25 mm-thick Duroid 6010 substrate with the dielectric constant of 10.2. The slotline is 0.1 mm wide. This corresponds to the Z_{S}, value of 72.8 Ohm. Given Z₀=50 Ohm and N₁=1, from EQ. 1 and EQ. 2, we obtain Z₁ and Z₂ of 42.7 Ohm and 60.4 Ohm, respectively.

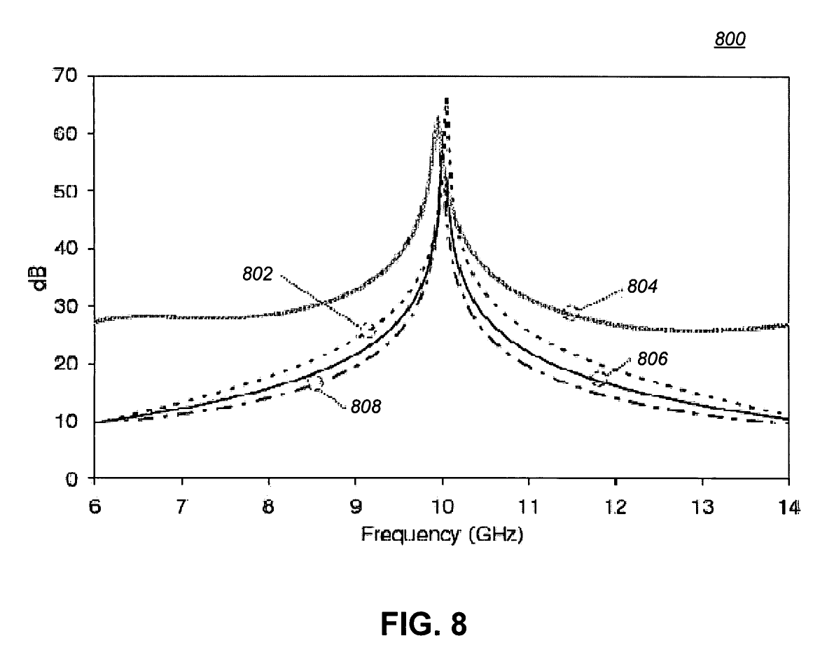

Using the circuit model in FIGS. 6 and 7, and the parameters at 10 GHz in Table I (infra), the Magic-T 100 frequency response to the tee junction is shown in FIG. 8. In particular, FIG. 8 shows the frequency response of Magic-T 100 using odd and even-mode circuit model. Label 802 shows the return loss of the difference port (118), label 804 shows the return loss of the first port 110, label 806 shows the isolation between the first and second ports, and label 808 shows the return loss of the sum port 108. Magic-T 100 provides better broadband out-of-phase combining response than the in-phase combining response. The in-phase combining bandwidth is limited by the two impedance transformation sections in Z₁ and Z₂ used to transform Z₀ at first port 110 to 2Z₀ at port 108 (sum port) in even mode. Moreover, the Z₂ value needs to satisfy the odd-mode matching condition.

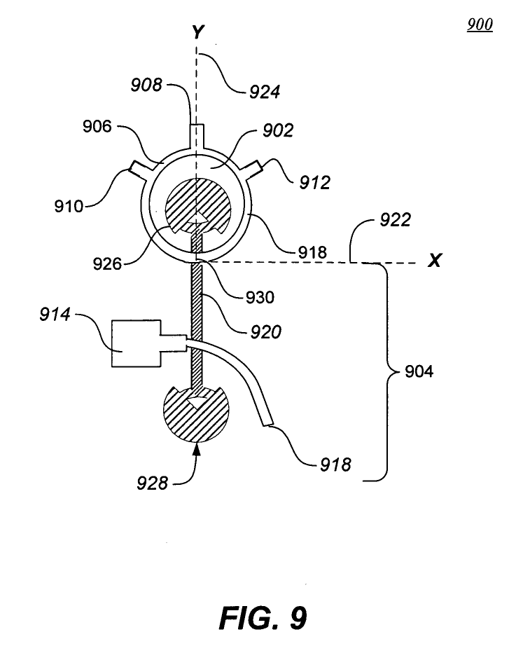

FIG. 9 is a diagram of microwave circuit arrangement 900 with a first and second input port coupled to the sum port through a one quarter wavelength long line in accordance to an embodiment. The microwave circuit arrangement 900 comprises a Magic-T 902, a microstrip-slotline transition 904, a sum port 908, a difference port 918, a first input port 910, and a second input port 912, and step impedance open stub 914. The first input port 910 is coupled to the sum port 908 by a quarter wavelength (λ/4) long line 906. The second input port 912 is coupled to the sum port 908 by a quarter wavelength (λ/4) long line (not labeled). The microstrip ring structure of Magic-T 902 minimizes parasitic couplings at the microstrip slotline tee junction 930, and simultaneously enhances the return loss at first input port 910, second input port 912 and difference port 918 and results in a small phase mismatch. In addition, microstrip ring structure of Magic-T 902 of the structure also increases the overall bandwidth significantly.

The Magic-T 902 has a top section, above first port 910 and second port 912, consists of two quarter wavelength (λ/4) lines with the characteristic impedance of Z₁. The first and second input ports are used as an in-phase combiner with sum port 908 between two Z₁ lines. The bottom section of the Magic-T contains two pairs of quarter wavelength (λ/4) lines 918 or one quarter wavelength (λ/2) as measured from microstrip-slotline tee junction 930 to second input port 912. Each pair contains two microstrip lines with the characteristic impedances of Z₂ and Z₃ connected in series. These lines are used to transform the microstrip at first port 910 and second port 912 to the slotline 920 with the characteristic impedance of Zₛₗ, and produce the microstrip-slotline tee junction 930 at the center of the structure. The Zₛₗ line is terminated with two slotline stepped circular rings (SCRs) 926, 928 at both ends to provide broadband virtual open. Finally, the slotline output is transformed to a microstrip output at difference port 918 using a microstrip-slotline transition. The magic-T 902 is analyzed in both odd and even modes up to the slotline Zₛₗ section.

When the signals from the first input port 910 and second input port 912 are out-of-phase. This creates a microstrip virtual ground plane along the Y-axis 924 of the magic-T and at sum port 908. The slotline SCR termination connected to the slotline 920 Zₛₗ allows microstrip-to-slotline mode conversion since the electric field and current flow towards the microstrip-slotline tee junction 930. In the even mode, the signals from first input port 910 and second input port 912 are in-phase, thus creating a microstrip virtual open along the Y-axis 924 of the magic-T 902. Electric-fields in the slotline at the microstrip-slotline tee junction 930 are canceled, thus creating a slotline virtual ground that prevents the signal flow to or from the difference port 918 by symmetry.

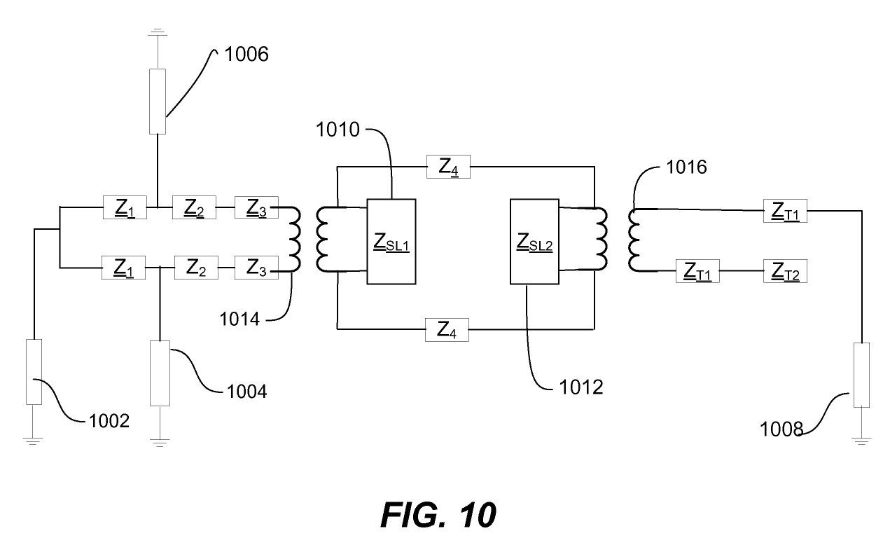

FIG. 10 is full circuit model 1000 of a model that approximates the Magic-T's response around the center frequency f₀. In the odd mode, the sum port 1002 becomes a virtual ground. Using a quarter wavelength (λ/4) transformation through Z₁ line, the virtual ground becomes an open at first input port 1006 and second input port 1004, both of which have a characteristic impedance of Z₀. To match the impedance at these ports, quarter wavelength (λ/4) transmission lines −Z₂ and Z₃—are used to transform Z₀ to the slot line impedance of n²Zₛₗ/2, where n is the microstrip-slotline transformer 1014 ratio and Zₛₗ is the impedance of slotline 920. In the single mode limit, n is dependent on the substrate thickness, the transmission line characteristic impedance and the microstrip slotline physical alignment. The general equation relating Z₀, Z₂, Z₃, and Zₛₗ (Z₄=Zₛₗ/2 in FIG. 10) can be expressed at f₀ as follows:

$${Z}_{0} = {{n}^{2} ( \frac{{Z}_{2}}{{Z}_{3}} )}^{2} \qquad EQ . 5$$

It is desirable that n²Zsl/2 equals Z₀ to eliminate the discontinuity of microstrip lines (i.e. Z₂=Z₃). In FIG. 10 the impedance of SCR 928 and 926 is labeled as Zₛₗ₁ and Zₛₗ₂. However, in the fabrication process, typically, the value Zₛₗ is limited by the allowable minimum slot width and the substrate thickness. To minimize the radiation loss of the transition, it is advisable to employ a minimum achievable slotline 920 width (Wₛₗ) of 0.1 mm on the 0.25 mm-thick Duroid® 6010 substrate made by the Roger Corporation, Roger, Conn. This slotline width corresponds to a Zₛₗ magnitude of 72.8 Ohm.

In the even mode, difference port 1008 becomes a virtual open and it is half-wavelength (λ/2) line transformed to an open at first input port 1006 and second input port 1004 Therefore, there is no constraint on the values Z₂ and Z₃ in this mode at f₀. Moreover, first input port 1006 and second input port 1004 impedances are transformed to 2Z₀ at sum port 1002 using the Z₁ line. The general solution can be obtained as follows:

z₁=\sqrt{2}*Z₀ EQ. 6

The microstrip-slotline transition 904 in the microwave circuit arrangement 900 requires proper terminations to maintain broad mode-conversion at the microstrip-slotline tee junction 930 and at difference port 918. The slotline SCR (926, 928) and the microstrip stepped impedance open stub (SIO, 914) terminations are used in this section due to its broadband characteristics. In addition, the slotline SCR is more compact and has lower radiation loss than many conventional slotline terminations. The slotline SCR is modeled using three transmission lines 208, 204, 206 with electrical lengths of θ₀, θ₁ and θ₂, respectively. These values correspond to the physical widths and lengths of Wₛ₀, Wₛₗ and Wₛ₂, and Lₛ₀, Lₛₗ and Lₛ₂, respectively. The microstrip stepped impedance open stub is modeled using two transmission lines Zₜ₁ and Zₜ₂ with electrical lengths of θₜ₁ and θₜ₂, respectively. These values correspond to the physical widths and lengths of Wₜ₁ and Wₜ₂, and Lₜ₁ and Lₜ₂, respectively.

### CONCLUSION

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments.

While the invention has been described in conjunction with specific embodiments therefore, it is evident that various changes and modifications may be made, and the equivalents substituted for elements thereof without departing from the true scope of the invention. In addition, many modifications may be made to adapt a particular situation or material to the teachings of the invention without departing from the scope thereof. Therefore, it is intended that this invention not be limited to the particular embodiment disclosed herein, but will include all embodiments within the spirit and scope of the disclosure. The terminology used in this application meant to include all waveguide, slotlines and microstrip slotline transitions environments and alternate technologies which provide the same functionality as described herein. For example, while the Magic-T has been described with planar waveguide circuits, retrace hybrids with microstrip coplanar waveguide transitions would be suitable alternatives.

We claim:

1. A microwave circuit arrangement, the microwave circuit arrangement comprising:
a Magic-T waveguide circuit element having a sum port;
a first input port coupled to the sum port by a transmission line, wherein the transmission line is at least a quarter wavelength long;
a second input port coupled to the sum port by a transmission line, wherein the transmission line is at least a quarter wavelength long;
a microstrip slotline transition circuit, wherein the microstrip slotline transition circuit has a difference port; and
a slotline having a first and second end coupling the Magic-T waveguide circuit element and the microstrip slotline transition circuit.

2. The microwave circuit arrangement of claim 1, the arrangement further comprising:
a first slotline stepped circular ring positioned within the Magic-T and coupled to the first end of the slotline.

3. The microwave circuit arrangement of claim 2, the arrangement further comprising:
a second slotline stepped circular ring positioned within the microstrip slotline transition circuit and coupled to the second end of the slotline.

4. The microwave circuit arrangement of claim 3, the arrangement further comprising:
a microstrip stepped impedance open-end (SIO) stub coupled to a first end of the difference port, wherein the difference port at the microstrip slotline transition circuit has a first end and a second end.

5. The microwave circuit arrangement of claim 3, wherein the slotline and the Magic-T waveguide circuit element form a microstrip slotline tee junction at the point of coupling.

6. The microwave circuit arrangement of claim 5, wherein microstrip slotline mode conversion occurs when a first signal at the first input port and a second signal at the second input port are out-of-phase.

7. The microwave circuit arrangement of claim 5, wherein out-of-phase signals at the first input port and the second input port are combined at the microstrip slotline tee junction.

8. The microwave circuit arrangement of claim 5, wherein in phase signals at the first input port and second input port are combined at the sum port of the Magic-T waveguide circuit element.

9. The microwave circuit arrangement of claim 5, wherein signals from the difference port of the microstrip slotline transition circuit are blocked when the signals at the first input port and second input port are in-phase.

10. A multi-port circuit for processing two incoming signals of arbitrary phase and amplitude to output two corresponding output signals, comprising:
a first input port coupled to a sum port by a transmission line, wherein the transmission line is at least a quarter wavelength long;
a second input port coupled to the sum port by a transmission line, wherein the transmission line is at least a quarter wavelength long;
a first half-wavelength long transmission line connecting a junction node and the first input port;
a second half-wavelength long transmission line connecting a junction node and the second input port;
a slotline having a first and second end terminated with slotline stepped circular ring (SCR) so that the input signals are combined at the junction node when the first and second incoming signals are out-of-phase, and wherein the first and second incoming signals are combined at the sum port when the first and second incoming signals are in-phase.

11. The four-port circuit of claim 10, the circuit further comprising:
a microstrip stepped impedance open-end (SIO) stub coupled to a difference port.

12. The four-port circuit of claim 10, wherein the junction node is a microstrip slotline tee junction.

13. The four-port circuit of claim 10, wherein the difference port is isolated from other ports in the multi-port circuit when the first and second incoming signals are in-phase.

14. The four-port circuit of claim 10, wherein the multi-port circuit is a Magic-T.

15. A method of manufacturing a Magic-T, the method comprising:
providing a Magic-T waveguide circuit element having a sum port;
positioning in the Magic-T waveguide circuit a first input port at least a quarter wavelength away from the sum port;
positioning in the Magic-T waveguide circuit a second input port at least a quarter wavelength away from the sum port;
coupling to the Magic-T waveguide circuit a slotline having a first and second end; wherein the first end is in the Magic-T waveguide circuit;
coupling a microstrip slotline transition circuit towards the second end of the slotline, wherein the microstrip slotline transition circuit has a difference port;
wherein a ground is caused at the sum port when in an odd mode, wherein the odd mode occurs when received signals at the first input port and second input port are out-of-phase; and
wherein the difference port becomes isolated when in an even mode, wherein the even mode occurs when received signals at the first input port and second input port are in-phase.

16. The method of claim 15, the method further comprising:
attaching a first slotline stepped circular ring to the first end of the slotline.

17. The method of claim 15, the method further comprising:
attaching a second slotline stepped circular ring at the second end of the slotline.

18. The method of claim 17, wherein the slotline and the Magic-T waveguide circuit element form a microstrip slotline tee junction at the point of coupling.

19. The method of claim 18, the method further comprising:
combining at the microstrip slotline tee junction out-of-phase received signals at the first input port and second input port.

20. The method of claim 15, the method further comprising:
attaching a microstrip stepped impedance open-end (SIO) stub to one end of the difference port.
